(19) United States
(12) Patent Application Publication
(10) Pub. No.: US 2025/0071757 A1
(43) Pub. Date: Feb. 27, 2025

(54) CONTROL CHANNEL MONITORING IN CELLULAR COMMUNICATIONS

(71) Applicant: Nokia Technologies Oy, Espoo (FI)

(72) Inventors: Sami-Jukka HAKOLA, Kempele (FI); Timo KOSKELA, Oulu (FI); Keeth Saliya Jayasinghe LADDU, Espoo (FI); Mihai ENESCU, Espoo (FI); Juha Pekka KARJALAINEN, Oulu (FI)

(21) Appl. No.: 18/727,779

(22) PCT Filed: Jan. 10, 2023
(86) PCT No.: PCT/EP2023/050367

§ 371 Date: Jul. 10, 2024

(30) Foreign Application Priority Data
Jan. 12, 2022 (FI) 20225023

(51) Int. Cl. H04W 72/1273; H04W 72/0446; H04W 72/115

(52) U.S. Cl. CPC H04W 72/1273; H04W 72/0446; H04W 72/115

(57) ABSTRACT

Devices, methods, apparatuses and computer readable storage media of monitoring in beam management with CORESETs associated with CSS and USS. The method includes monitoring a first downlink control channel associated with a first type of CORESET based on a first TCI state; and in accordance with a determination that a first TCI is different from a second TCI state used for the first device to monitor a second downlink control channel associated with a second type of CORESET, determining a reception of a first downlink data channel associated with the first type of CORESET based at least partially on a scheduling offset.

### FIELD

Embodiments of the present disclosure generally relate to the field of telecommunication and in particular to devices, methods, apparatuses and computer readable storage media of monitoring in beam management with Control Resource Sets (CORESETs) associated with Common Search Space (CSS) and User specific Search Space (USS).

### BACKGROUND

In the 3rd Generation Partnership Project (3GPP) New Radio (NR), multi-beam/beam management enhancements involving inter-cell beam management has been proposed. A User Equipment (UE) may receive and transmit signals and channels associated to physical cell ID (PCI) different than PCI of the serving cell. Thus, the UE may monitor PDCCH both from the serving cell and from PCI different than PCI of the serving cell.

### SUMMARY

In general, example embodiments of the present disclosure provide a solution of monitoring in inter-cell beam management with CORESETs associated with CSS and USS.

In a first aspect, there is provided a first device. The first device comprises at least one processor; and at least one memory including computer program codes; the at least one memory and the computer program codes are configured to, with the at least one processor, cause the first device at least to monitor a first downlink control channel associated with a first type of CORESET based on a first Transmission Coordination Indicator (TCI) state; and in accordance with a determination that a first TCI is different from a second TCI state used for the first device to monitor a second downlink control channel associated with a second type of CORESET, determine a reception of a first downlink data channel associated with the first type of CORESET based at least partially on a scheduling offset.

In a second aspect, there is provided a method. The method comprises monitoring a first downlink control channel associated with a first type of CORESET based on a first Transmission Coordination Indicator (TCI) state; and in accordance with a determination that a first TCI state is different from a second TCI state used for the first device to monitor a second downlink control channel associated with a second type of CORESET, determining a reception of a first downlink data channel associated with the first type of CORESET based at least partially on a scheduling offset.

In a third aspect, there is provided an apparatus comprising means for monitoring a first downlink control channel associated with a first type of CORESET based on a first Transmission Coordination Indicator (TCI) state; and in accordance with a determination that a first TCI state is different from a second TCI state used for the first device to monitor a second downlink control channel associated with a second type of CORESET, means for determining a reception of a first downlink data channel associated with the first type of CORESET based at least partially on a scheduling offset.

In a fourth aspect, there is provided a computer readable medium comprising program instructions stored thereon for performing at least monitoring a first downlink control channel associated with a first type of Control Resource Set, CORESET based on a first Transmission Coordination Indicator, TCI, state; and in accordance with a determination that a first TCI state associated with the first type of CORESET is different from a second TCI state used for the first device to monitor a second downlink control channel associated with a second type of CORESET, determining a reception of a first downlink data channel associated with the first type of CORESET based at least partially on a scheduling offset

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example environment in which example embodiments of the present disclosure can be implemented;

FIG. 2 an example of UE monitoring PDCCH on different CORESET types according to some example embodiments of the present disclosure;

FIG. 3 shows a signaling chart illustrating a process of monitoring in inter-cell beam management with CORESETs associated with CSS and USS according to some example embodiments of the present disclosure;

FIG. 4 shows a flowchart of an example method of monitoring in inter-cell beam management with CORESETs associated with CSS and USS according to some example embodiments of the present disclosure;

FIG. 5 shows a simplified block diagram of a device that is suitable for implementing example embodiments of the present disclosure; and

FIG. 6 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements. These elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

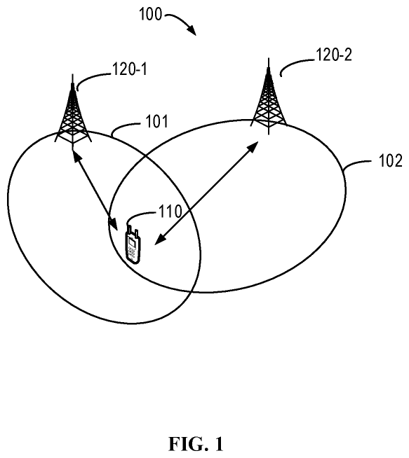

FIG. 1 shows an example communication network 100 in which embodiments of the present disclosure can be implemented. As shown in FIG. 1, the communication network 100 may comprise a terminal device 110 (hereinafter may also be referred to as a UE 110 or a first device 110). The communication network 100 may further comprise network devices 120-1 and 120-2, which may communicate with the terminal device 110 within the coverage of cells 101 and 102, respectively. Hereinafter the network device 120-1 may also be referred to as a first gNB 120-1 and the network device 120-2 may also be referred to as a second gNB 120-2.

In the communication network 100, the cell 101 associated with the network device 120-1 may act as the serving cell 101 of the terminal device 110, while the cell 102 associated with the network device 120-2 may act as a non-serving cell 102 of the terminal device 110.

It is to be understood that the number of network devices and terminal devices shown in FIG. 1 is given for the purpose of illustration without suggesting any limitations. The communication network 100 may include any suitable number of network devices and terminal devices.

Beam management comprises a set of procedures and functionalities that enable, maintain and refine Receive (RX) and Transmit (TX) beams alignment between the transmitter and the receiver(s). A beam pair link established between the transmitter and the receiver may comprise a Tx beam and Rx beam pair. The beam pair link between the gNB and the UE may be the same or different in downlink (DL) and uplink (UL). In DL, the gNB may provide the UE with a quasi-co-location (QCL)-TypeD Reference Signal (RS) based on which the UE can set its Rx beam, spatial relation information in UL, and the Rx beam.

The QCL of two antenna ports means that the channel conditions for the symbols transmitted from those antenna ports are similar. Depending on the set of properties for the channel conditions, the following QCL-types have been defined, namely QCL-TypeA, QCL-TypeB, QCL-Type and QCL-TypeD.

The QCL defines the relation between two reference signals at the UE receiver. In practice, the gNB can only guarantee that the properties of two reference signals are similar if the two reference signals are transmitted from the same transmission and reception point (TRP). NR considers in general that the transmission of any reference signal from any TRP.

The QCL-TypeD RS may refer to Synchronization Signal Block (SSB) or Channel State Information Reference Signal (CSI-RS). In beam indication for the target signal to be received (for example, Demodulation Reference Signal (DMRS) of Physical Downlink Shared Channel (PDSCH), DMRS of Physical Downlink Control Channel (PDCCH), and CSI-RS), the UE may be provided with a TCI state (container) that comprises an indication of the QCL-TypeD RS. The UE may applied the same RX beam to receive target signal, as it used to receive the given QCL-TypeD RS (SSB or CSI-RS resource) in the TCI state. The UE can be configured with up to 64 or 128 (if UE capability allows) TCI states.

In UL, the UE may be provided a spatial source RS, which may refer to an SSB, CSI-RS or Sounding Reference Signal (SRS). In case of SSB or CSI-RS, the UE may use the RX beam used to receive the given SSB or CSI-RS resource as spatial relation for the TX beam to transmit target signal (for example, Physical Uplink Control Channel (PUCCH), Physical Uplink Shared Channel (PUSCH), SRS). In case of SRS, the UE may use the TX beam to transmit target signal, which may be the same TX beam as is used to transmit the given SRS resource.

For the beam Management, the main procedure may comprise measurements and reporting of candidate reference signals and beam indication and/or beam switching. The measurements and reporting of candidate reference signals may act as a source to determine transmit and receive beam pair in downlink and in uplink. In the procedure of beam indication and/or beam switching, in DL, the UE is provided with a TCI state for the target signal, based on which the UE can receive the target signal, while in UL, the UE is provided with a spatial relation for the target signal based on which the UE forms the transmit beam.

In general, the beam Management defines a set of functionalities to assist UE to set its RX and TX beams for downlink receptions and uplink transmissions, respectively. The functionalities can be categorized roughly according to four groups, namely beam indication, beam acquisition, measurement and reporting, beam recovery and beam tracking and refinement.

Regarding downlink beam management and especially for beam acquisition, measurements and reporting, some beam management procedures are supported within one or multiple Transceiver Points (TRPs) of the serving cell. For example, UE measurement on different TRP Tx beams may be enabled to support selection of TRP Tx beams/UE Rx beam(s). UE measurement on different TRP Tx beams may be enabled to possibly change inter/intra-TRP Tx beam(s). UE measurement on the same TRP Tx beam may be enabled to change UE Rx beam in the case UE uses beamforming.

Regarding downlink beam indication, the QCL indication functionality has been defined. The principle to receive certain physical signal or physical channel is: the UE is either configured with or the UE implicitly determines a source/reference RS that UE has received and measured earlier which may define how to set RX beam for the reception of the downlink (target) physical signal or channel to be received. To provide UE with QCL characteristics for the target signal (to be received), a TCI framework has been defined, using which UE can be configured with TCI state(s) to provide UE with source RS(s) for determining QCL characteristics. Each TCI state includes one or two source RSs that provide UE QCL TypeA, TypeB, TypeC and/or TypeD parameters.

In uplink, the UE may be provided with a parameter called spatial relation information which may provide a spatial source RS. Based on spatial source RS, the UE may determine the UL Tx beam. The spatial source RS may refer to Downlink (DL) RS, such as Synchronization Signal Block (SSB) or Channel State Information Reference Signal (CSI-RS), or UL RS, such as SRS. For each Physical Uplink Control Channel (PUCCH) and SRS resource, the gNB may provide explicitly spatial source while for Physical Uplink Shared Channel (PUSCH) indirect indication is provided.

In release 16, a default spatial relation for dedicated PUCCH/SRS and a default spatial relation for PUSCH scheduled by DCI format 0_0 have been introduced. In release 17, the unified TCI framework has been introduced, which means that TCI states so far providing QCL assumptions for the reception of DL signals and channels would be used also to provide spatial sources for the transmission of UL signals and channels.

Furthermore, the unified TCI framework defines the concept of indicated TCI state. The indicated TCI state can be joint DL and UL TCI state or separate DL and separate UL TCI states. The indicated TCI state provides QCL source (DL) and spatial source (UL) for the set of downlink signals and channels and for the set of uplink signals and channels, respectively. In release 17, there can be one indicated joint DL and UL or one indicated DL and one indicate UL TCI state for the UE. The unified TCI framework is expected to be extended in release 18 so that there can be then multiple indicated DL and UL TCI states.

In the procedure for the gNB to generate a PDCCH, if the size of the Downlink Control Information (DCI) format is less than 12 bits, a few zero padding bits will be appended until the payload size equals 12bits. For the DCI payload bits, a 24-bit cyclic redundancy check (CRC) can be calculated and appended to the payload. The CRC may allow the UE to detect the presence of errors in the decoded DCI payload bits. After the CRC is attached, the last 16 CRC bits are masked with a corresponding identifier, referred to as a Radio Network Temporary Identifier (RNTI).

By using the RNTI mask, the UE may detect the DCI for its unicast data and distinguish sets of DCI with different purposes that have the same payload size. The CRC attached bits are then interleaved to distribute the CRC bits among the information bits. The interleaver may support a maximum input size of 164 bits. This means that DCI without CRC can have at most 140 of payload bits. The bits are then encoded by the polar encoder to protect the DCI against errors during transmission. The encoder output is processed using a sub-block interleaver and then rate matched to fit the allocated payload resource elements (REs) of the DCI.

The payload bits of each DCI are separately scrambled by a scrambling sequence generated from the length-31 gold sequence. The scrambling sequence is initialized by the physical layer cell identity of the cell or by a UE specific scrambling identity and a UE specific cell RNTI (C-RNTI). After the scrambled DCI bit sequence is Quadrature Phase Shift Keying (QPSK) modulated, the complex-valued modulation symbols are mapped to physical resources in units referred to as control channel elements (CCEs). Each CCE may consist of six resource element groups (REGs), where a REG may be defined as one Physical Resource Block (PRB) in one Orthogonal Frequency Division Multiplexing (OFDM) symbol which contains nine REs for the PDCCH payload and three DMRS REs.

For each DCI, 1, 2, 4, 8, or 16 CCEs can be allocated, where the number of CCEs for a DCI is denoted as aggregation level (AL). With QPSK modulation, a CCE contains 54 payload REs and therefore can carry 108 bits. This requires the output size of the rate matching block to be L·108, where L is the associated AL. Based on the channel environment and available resources, the gNB can adaptively choose a proper AL for a DCI to adjust the code rate.

A DCI with AL=L is mapped to physical resources in a given Bandwidth Part (BWP), where necessary parameters such as frequency and time domain resources, and scrambling sequence identity for the DMRS for the PDCCH are configured to a UE by means of CORESET. A UE may be configured with up to three CORESETs in release 15 and up to five CORESETs in release 16 (for multi-DCI multi-TRP operation) on each of up to four BWPs of a serving cell. In general, CORESETs may be configured in units of six PRBs on a six PRB frequency grid and one, two, or three consecutive OFDM symbols in the time domain.

A DCI of AL=L comprises L continuously numbered CCEs, and the CCEs are mapped on a number of REGs in a CORESET. NR supports distributed and localized resource allocation for a DCI in a CORESET. This is done by configuring interleaved or non-interleaved CCE-to-REG mapping for each CORESET. For interleaved CCE-to-REG mapping, the REG bundles constituting the CCEs for a PDCCH are distributed in the frequency domain in units of REG bundles. A REG bundle is a set of indivisible resources consisting of neighbouring REGs. A REG bundle spans across all OFDM symbols for the given CORESET. Once the REGs corresponding to a PDCCH are determined, the modulated symbols of the PDCCH are mapped to the REs of the determined REGs in the frequency domain first and the time domain second, i.e., in increasing order of the RE index and symbol index, respectively.

In the procedure of PDCCH monitoring, the UE may perform blind decoding for a set of PDCCH candidates. The PDCCH candidates to be monitored may be configured for a UE by means of Search Space (SS) sets. There are two SS set types, namely CSS and USS. The CSS may be commonly monitored by a group of UEs in the cell, while the USS may be monitored by an individual UE. A UE can be configured with up to 10 SS sets each for up to four BWPs in a serving cell. In general, SS set configuration may provide a UE with the SS set type (CSS set or USS set), DCI format(s) to be monitored, monitoring occasion, and the number of PDCCH candidates for each AL in the SS set.

A SS set with index s is associated with only one CORESET with index p. The UE may determine the slot for monitoring the SS set with index s based on the higher layer parameters for periodicity k, offset o, and duration d, where the periodicity k and the offset o may provide a starting slot and the duration d may provide the number of consecutive slots, where the SS set is monitored starting from the slot identified by k and o.

The UE is monitoring PDCCH on the certain CORESET based on the activated TCI state of the CORESET if the CORESET is associated with CSS. The TCI state may provide UE with two QCL-Type source RSs at carrier frequencies where receive beamforming is applied. One of the source RSs is the QCL-TypeD source based on which the UE is able to set its Rx beam properly. Principle is that the UE shall be able to receive PDCCH with the same RX beam as it used to receive the given QCL-TypeD source RS. Before the UE has been provided TCI state for PDCCH monitoring, the UE applies the SSB used in the random access.

For the CORESET associated with USS, the UE may apply the indicated TCI state that provides the QCL-TypeD RS based on which the UE determines its Rx beam. The indicated TCI state may also be applied for corresponding PDSCH(s) (scheduled via the said CORESET) and CSI-RS if configured to follow the indicated TCI state.

As described above, monitoring of the PDCCH on the CORESET associated with USS (hereinafter may also be referred to as CORESET A) is based on the indicated TCI state while monitoring of the PDCCH on the CORESET associated with CSS (hereinafter may also be referred to as CORESET B) is based on the activated TCI state for the CORESET.

Indicated TCI state may act as a default beam as well replacing existing default PDSCH beam assumption. However, that is not possible when the UE monitors CORESET B because the indicated TCI state is not applied. And if the UE is scheduled from the CORESET B with the scheduling offset less than a parameter associated with default beam assumptions called timeDurationForQCL, the UE may apply the default QCL assumption for the reception of the PDSCH which is the TCI state of the CORESET monitored in the latest slot.

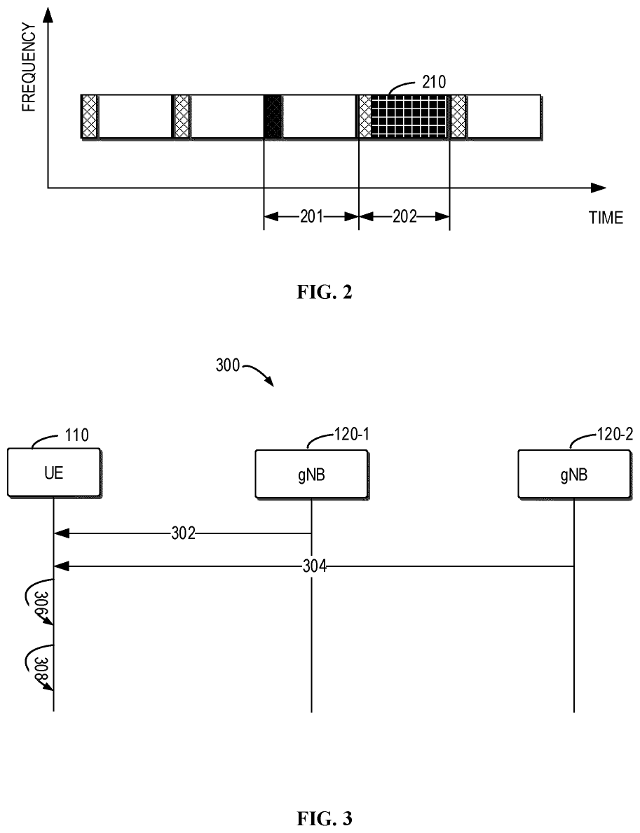

FIG. 2 an example of UE monitoring PDCCH on different CORESET types according to some example embodiments of the present disclosure. As shown, the UE performs a monitoring of the PDCCH on the CORESET B in the slot 201, if a PDSCH 210 is scheduled for the UE, for example, with scheduling offset of one slot when the timeDurationForQCL is two slots, the UE may not receive the PDSCH 210, since the UE apply the indicated TCI state for monitoring PDCCH on CORESET A in the slot 202. The indicated TCI state is from the non-serving cell while the PDSCH 210 is transmitted from the serving cell.

The solution of the present disclosure proposes a mechanism of monitoring in inter-cell beam management with CORESETs associated with CSS and USS. In this solution, the UE may monitor a first downlink control channel associated with a first type of CORESET based on a first TCI state. If the UE determines that a first TCI is different from a second TCI state used for the first device to monitor a second downlink control channel associated with a second type of CORESET, the UE may determine a reception of a first downlink data channel associated with the first type of CORESET based at least partially on a scheduling offset

Principle and implementations of the present disclosure will be described in detail below with reference to FIG. 3, which shows a signaling chart illustrating a process 300 of monitoring in inter-cell beam management with CORESETs associated with CSS and USS according to some example embodiments of the present disclosure. For the purpose of discussion, the process 300 will be described with reference to FIG. 1. The process 300 may involve the UE 110, the gNB 120-1 and the gNB 120-2.

In this case, the gNB 120-1 may manage a serving cell of the UE 110 and the gNB 120-2 may manage a non-serving cell associated with the UE 110.

Now the reference is made to FIG. 3. As shown, the UE 110 may receive 302 a configuration of CSS set(s) from the gNB 120-1 and receive 304 a configuration of USS set(s) from the gNB 120-2 or from the gNB 120-1.

The UE 110 may also obtain an association of CSS to a first type of CORESET (may also be referred to as CORESET B). In some example embodiments, the UE 110 may receive a configuration that the CORESET B does not follow indicated TCI state but explicitly activated TCI state that is used to monitor CORESET B.

The UE 110 may also obtain an association of USS to a second type of CORESET (may also be referred to as CORESET A).

It is to be understood that a CSS type 3 can be considered as the USS or the CSS. In general, the Type3 CSS is for DCI formats with Cyclic Redundancy Check (CRC) scrambled by Interrupted Transmission indication Radio Network Temporary Identifier (INT-RNTI), Slot Format Indication Radio Network Temporary Identifier (SFI-RNTI), Transmit Power Control Physical Uplink Shared Channel Radio Network Temporary Identifier (TPC-PUSCH-RNTI), Transmit Power Control Physical Uplink Control Channel Radio Network Temporary Identifier (TPC-PUCCH-RNTI), Transmit Power Control Sounding Reference Symbols Radio Network Temporary Identifier (TPC-SRS-RNTI), or CI-RNTI and, only for the primary cell, Cell Radio Network Temporary Identifier (C-RNTI), Modulation Coding Scheme Cell Radio Network Temporary Identifier (MCS-C-RNTI), Configured Scheduling Radio Network Temporary Identifier(s) (CS-RNTI(s)), or PS-RNTI. And a non-Type3 CSS may be referred as, for example, a CSS other than Type3, such as a Type0, Type0A, Type1 or Type2 CSS.

Thus, in some scenarios, the CORESET B may be is associated with the CSS and the CORESET A may be associated with the USS. In other scenarios, the CORESET B may be is associated with the non-Type3 CSS and the CORESET A may be associated with the USS or the Type3 CSS.

Furthermore, the UE 110 may receive MAC or DCI based indication of the indicated TCI state. The UE 110 may apply the indicated TCI state to CORESET A monitoring.

The UE 110 may perform 306 a monitoring on a PDCCH associated with CORESET B and determine 308 a reception of a PDSCH based on the monitoring on the PDCCH.

If the UE determines that the activated TCI state of CORESET B is different from the indicated TCI state of CORSET A, the UE 110 may determine a reception of a PDSCH also by considering the scheduling offset associated with the scheduling grant.

In the present disclosure, the activated TCI state may also be referred to as a first TCI state and the indicated TCI state may be referred to as a second TCI state. The first TCI state is different from the second TCI state may refer to QCL source RS in first TCI state may have different QCL-TypeD characteristics than QCL source RS in second TCI state. It is also possible that QCL source RS in first TCI state is associated to different PCI than QCL source RS in second TCI state. The first TCI state is different from the second TCI state may also refer to QCL source RS in the first TCI state and QCL source RS in the second TCI state are not in the same QCL chain.

By the monitoring on the PDCCH, if the UE 110 receives the symbols after CORESET B in a first slot based on the QCL assumption defined by CORESET B, i.e., based on the activated TCI state of the CORESET B and the UE 110 detects the scheduling grant with a scheduling offset of zero for the PDSCH in the first slot, the UE 110 may perform a demodulation of the PDSCH based on the scheduling grant.

In some example embodiments, if the UE 110 receives the symbols after CORESET B in a first slot based on the activated TCI state of the CORESET B and the UE 110 detects the scheduling grant with a scheduling offset equal to or greater than timeDurationForQCL, the UE 110 may perform the monitoring on PDCCH in a second slot next to the first slot based on the indicated TCI state. If the UE 110 further receives the symbols of the second slot based on the indicated TCI state, the UE 110 may perform the reception of the PDSCH scheduled via CORESET B in a time period provided by the scheduling offset.

In some example embodiments, if the UE 110 receives the symbols after CORESET B in a first slot based on the activated TCI state of the CORESET B and the UE 110 detects the scheduling grant with a scheduling offset less than timeDurationForQCL on the PDCCH associated with the CORESET B, the UE may apply the activated TCI state of the CORESET B for the reception of the PDSCH in a time period provided by the scheduling offset.

It is to be understood that there could be multiple CORESET Bs associated with CSS). In that case the latest monitored CORESET B may define the default QCL assumption to be applied in the slot(s) defined by timeDurationForQCL after the detection of PDCCH in the monitoring occasion of CORESET B.

In this way, a mechanism for default QCL assumptions in the case where the UE applies the indicated TCI state for one and more CORESET(s) and the normal (activated) TCI state for other one or more CORESET(s) in order to receive PDSCH when the scheduling offset is less than timeDurationForQCL, which may avoid that a reception of the scheduled grant from the serving gNB is missed when the UE monitors on the control channel associated with a non-serving gNB, because the UE may be able to receive from only one RX beam (or receive spatial filter) at a time (i.e., no simultaneous reception from two directions at a time).

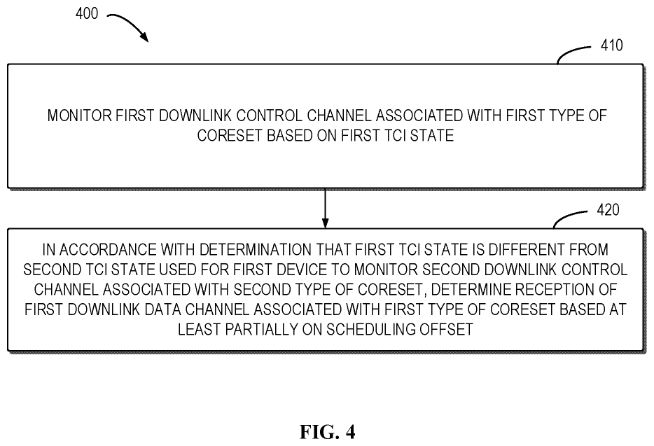

FIG. 4 shows a flowchart of an example method 400 of monitoring in inter-cell beam management with CORESETs associated with CSS and USS according to some example embodiments of the present disclosure. The method 400 can be implemented at the first device 110 as shown in FIG. 1. For the purpose of discussion, the method 400 will be described with reference to FIG. 1.

At 410, the first device monitors a first downlink control channel associated with a first type of CORESET based on a first TCI state.

At 420, if the first device determines that a first TCI state is different from a second TCI state used for the first device to monitor a second downlink control channel associated with a second type of CORESET, the first device determines a reception of a first downlink data channel associated with the first type of CORESET based at least partially on a scheduling offset.

In some example embodiments, the first type of CORESET is associated with a CSS and the second type of CORESET is associated with a USS.

In some example embodiments, the first type of CORESET is associated with a non-Type3 common search space and the second type of CORESET is associated with a user specific search space or a Type3 common search space.

In some example embodiments, if the first device determines that symbols after the first type of CORESET in a first slot are received based on the first TCI state and a scheduling grant with the scheduling offset of zero associated with the first downlink data channel is detected in the first slot, the first device may perform a demodulation of the first downlink data channel based on the scheduling grant.

In some example embodiments, if the first device determines that symbols after the first type of CORESET in a first slot are received based on the first TCI state and a scheduling grant with the scheduling offset equal to or greater than a time duration for a Quasi co-location is detected in the first slot, the first device may monitor, based on the second TCI state, the first downlink control channel in a second slot subsequent to the first slot. If the first device determines that further symbols are received in the second slot based on the second TCI state, the first device may perform the reception of the first downlink data channel in a time period provided by the scheduling offset.

In some example embodiments, if the first device determines that symbols after the first type of CORESET in a first slot are received based on the first TCI state and a scheduling grant with the scheduling offset less than a time duration for a Quasi co-location is detected in the first slot, the first device may perform, based on the first TCI state, the reception of the first downlink data channel in a time period provided by the scheduling offset.

In some example embodiments, the first TCI state is an activated TCI state, and the second TCI state is an indicated TCI state.

In some example embodiments, an apparatus capable of performing the method 400 (for example, implemented at the UE 110) may comprise means for performing the respective steps of the method 400. The means may be implemented in any suitable form. For example, the means may be implemented in a circuitry or software module.

In some example embodiments, the apparatus comprises means for monitoring a first downlink control channel associated with a first type of CORESET based on a first Transmission Coordination Indicator (TCI) state; and means for in accordance with a determination that a first TCI state associated with the first type of CORESET is different from a second TCI state used for the first device to monitor a second downlink control channel associated with a second type of CORESET, means for determining a reception of a first downlink data channel associated with the first type of CORESET based on the monitoring and a scheduling offset.

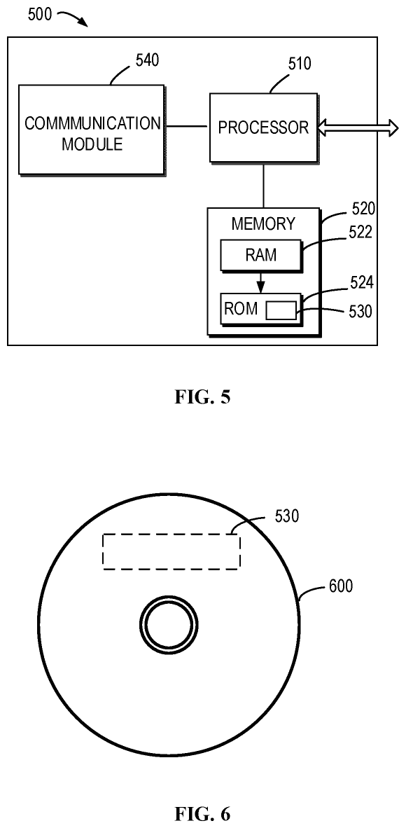

FIG. 5 is a simplified block diagram of a device 500 that is suitable for implementing embodiments of the present disclosure. The device 500 may be provided to implement the communication device, for example the UE 110 as shown in FIG. 1. As shown, the device 500 includes one or more processors 510, one or more memories 540 coupled to the processor 510, and communication modules 540 coupled to the processor 510.

The communication module 540 is for bidirectional communications. The communication module 540 has one or more communication interfaces to facilitate communication with one or more other modules or devices. The communication interfaces may represent any interface that is necessary for communication with other network elements. In some example embodiments, the communication module 540 may include at least one antenna.

The processor 510 may be of any type suitable to the local technical network and may include one or more of the following: general purpose computers, special purpose computers, microprocessors, digital reference signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The program 530 may be stored in the ROM 524. The processor 510 may perform any suitable actions and processing by loading the program 530 into the RAM 522.

The embodiments of the present disclosure may be implemented by means of the program 530 so that the device 500 may perform any process of the disclosure as discussed with reference to FIGS. 2 to 4. The embodiments of the present disclosure may also be implemented by hardware or by a combination of software and hardware.

In some embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. The computer readable medium may include any types of tangible non-volatile storage, such as ROM, EPROM, a flash memory, a hard disk, CD, DVD, and the like. FIG. 6 shows an example of the computer readable medium 600 in form of CD or DVD. The computer readable medium has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 400 as described above with reference to FIG. 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a reference signal, computer readable medium, and the like.

The computer readable medium may be a computer readable reference signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-15. (canceled)

16. A first device comprising:
at least one processor; and
at least one memory including computer program codes;
the at least one memory and the computer program codes are configured to, with the at least one processor, cause the first device at least to:
monitor a first downlink control channel associated with a first type of Control Resource Set, CORESET based on a first Transmission Coordination Indicator, TCI, state; and
in accordance with a determination that a first TCI state is different from a second TCI state used for the first device to monitor a second downlink control channel associated with a second type of CORESET, determine a reception of a first downlink data channel associated with the first type of CORESET based at least partially on a scheduling offset.

17. The first device of claim 16, wherein the first type of CORESET is associated with a common search space and the second type of CORESET is associated with a user specific search space.

18. The first device of claim 16, wherein the first type of CORESET is associated with a non-Type3 common search space and the second type of CORESET is associated with a user specific search space or a Type3 common search space.

19. The first device of claim 17, wherein the first device is caused to determine the reception of the first downlink data channel by:
in accordance with a determination that symbols after the first type of CORESET in a first slot are received based on the first TCI state and a scheduling grant with the scheduling offset of zero associated with the first downlink data channel is detected in the first slot, performing a demodulation associated with the first downlink data channel based on the scheduling grant.

20. The first device of claim 17, wherein the first device is caused to determine the reception of the first downlink data channel by:
in accordance with a determination that symbols after the first type of CORESET in a first slot are received based on the first TCI state and a scheduling grant with the scheduling offset equal to or greater than a time duration for a Quasi co-location is detected in the first slot, monitoring, based on the second TCI state, the first downlink control channel in a second slot subsequent to the first slot; and
in accordance with a determination that further symbols are received in the second slot based on the second TCI state, performing the reception of the first downlink data channel in a time period provided by the scheduling offset.

21. The first device of claim 17, wherein the first device is caused to determine the reception of the first downlink data channel by:
in accordance with a determination that symbols after the first type of CORESET in a first slot are received based on the first TCI state and a scheduling grant with the scheduling offset less than a time duration for a Quasi co-location is detected in the first slot, performing, based on the first TCI state, the reception of the first downlink data channel in a time period provided by the scheduling offset.

22. The first device of claim 16, wherein the first TCI state is an activated TCI state, and the second TCI state is an indicated TCI state.

23. A method comprising:
monitoring a first downlink control channel associated with a first type of Control Resource Set, CORESET based on a first Transmission Coordination Indicator, TCI, state; and
in accordance with a determination that a first TCI state associated with the first type of CORESET is different from a second TCI state used for the first device to monitor a second downlink control channel associated with a second type of CORESET, determining a reception of a first downlink data channel associated with the first type of CORESET based at least partially on a scheduling offset.

24. The method of claim 23, wherein the first type of CORESET is associated with a common search space and the second type of CORESET is associated with a user specific search space.

25. The method of claim 23, wherein the first type of CORESET is associated with a non-Type3 common search space and the second type of CORESET is associated with a user specific search space or a Type3 common search space.

26. The method of claim 24, wherein determining the reception of the first downlink data channel comprises:
in accordance with a determination that symbols after the first type of CORESET in a first slot are received based on the first TCI state and a scheduling grant with the scheduling offset of zero associated with the first downlink data channel is detected in the first slot, performing a demodulation associated with the first downlink data channel based on the scheduling grant.

27. The method of claim 24, wherein determining the reception of the first downlink data channel comprises:
in accordance with a determination that symbols after the first type of CORESET in a first slot are received based on the first TCI state and a scheduling grant with the scheduling offset equal to or greater than a time duration for a Quasi co-location is detected in the first slot, monitoring, based on the second TCI state, the first downlink control channel in a second slot subsequent to the first slot; and
in accordance with a determination that further symbols are received in the second slot based on the second TCI state, perform the reception of the first downlink data channel associated with the first type of CORESET in a time period provided by the scheduling offset.

28. The method of claim 24, wherein determining the reception of the first downlink data channel comprises:
in accordance with a determination that symbols after the first type of CORESET in a first slot are received based on the first TCI state and a scheduling grant with the scheduling offset less than a time duration for a Quasi co-location is detected in the first slot, performing, based on the first TCI state, the reception of the first downlink data channel associated with the first type of CORESET in a time period provided by the scheduling offset.

29. The method of claim 23, wherein the first TCI state is an activated TCI state, and the second TCI state is an indicated TCI state.

30. A computer readable medium comprising program instructions stored thereon for performing at least the following:
monitoring a first downlink control channel associated with a first type of Control Resource Set, CORESET based on a first Transmission Coordination Indicator, TCI, state; and
in accordance with a determination that a first TCI state associated with the first type of CORESET is different from a second TCI state used for the first device to monitor a second downlink control channel associated with a second type of CORESET, determining a reception of a first downlink data channel associated with the first type of CORESET based at least partially on a scheduling offset.
